(19) United States
(12) Patent Application Publication
(10) Pub. No.: US 2026/0036233 A1
(43) Pub. Date: Feb. 5, 2026

(54) FLUID CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HSIU-YUAN HSU, New Taipei (TW); MING-YUE CHEN, New Taipei (TW); YAO-CHI HUANG, New Taipei (TW); WEN HE, Kunshan (CN); LING-XIONG LI, Shenzhen (CN); LING TAO, Shenzhen (CN)

(21) Appl. No.: 19/289,367

(22) Filed: Aug. 4, 2025

(30) Foreign Application Priority Data
Aug. 2, 2024 (CN) 202411059596.2

(51) Int. Cl. F16L 29/00; F16K 5/06; F16K 31/528

(52) U.S. Cl. CPC F16L 29/002; F16K 5/0605; F16K 31/528

(57) ABSTRACT

A fluid connector includes a shell having a fluid channel, a ball valve accommodated in the shell and having a through hole, a control element arranged outside the shell for controlling the ball valve to rotate, and a pin member. A front end of the shell for engaging a matching connector has an engagement hole. The control element controls the ball valve between a closed position and an open position. The through hole is in fluid communication with the fluid channel when the ball valve is at the open position. A front face of the shell has an accommodating hole for accommodating the pin member. A resilient member is arranged in the accommodating hole for supporting the pin member.

### BACKGROUND OF THE INVENTION

### Field of the Invention

The present invention relates to a fluid connector, particularly to a fluid connector preventing leakage which has a simple structure and is easy to manufacture.

### Description of Related Arts

U.S. Pat. No. 8,132,781 discloses a fluid connector including a shell, a ball valve accommodated in the shell, a handle arranged outside the shell for controlling the ball valve, a detecting pin protruding from a front face of the shell under a normal state, and a locking pin for engaging an engagement hole of a matching fluid connector. The handle can drive the locking pin to extend out of the front face of the shell. The detecting pin can control whether the locking pin and the handle can be linked through a locking member, e.g., a roller element. However, the fluid connector has many units and a complicated structure. China Patent Application Publication No. 117052931 discloses an improvement to such fluid connector wherein a corresponding handle directly interacts with a corresponding roller element.

### SUMMARY OF THE INVENTION

A fluid connector includes a shell having a fluid channel, a ball valve accommodated in the shell and having a through hole, a control element arranged outside the shell for controlling the ball valve to rotate, and a pin member. A front end of the shell for engaging a matching connector has an engagement hole. The control element controls the ball valve between a closed position and an open position. The through hole is in fluid communication with the fluid channel when the ball valve is at the open position. A front face of the shell has an accommodating hole for accommodating the pin member. A resilient member is arranged in the accommodating hole for supporting the pin member. The pin member is resiliently supported by the resilient member and positioned at a first position extending out of the accommodating hole when the fluid connector is free of engagement to a matching connector. When the fluid connector abuts the matching connector, the pin member presses the resilient member and retracts to a second position in the accommodating hole. When the fluid connector abuts the matching connector and is rotated such that the pin member corresponds to an engagement hole of the matching connector, the pin member is pushed by the resilient member and is positioned at a third position extending into the engagement hole. The fluid connector comprises a restricting member positioned between the control element and the pin member. When the pin member is positioned at the first position or at the second position, the restricting member prevents the control element from rotating the ball valve. When the pin member is positioned at the third position, the control element is free of restriction by the restricting member and is able to control the ball valve to rotate.

### BRIEF DESCRIPTION OF DRAWINGS

FIG. 1 shows a perspective view of a fluid connector and a matching connector according to the present disclosure;

FIG. 2 shows a perspective view of a control element of the fluid connector at an unopened state according to the present disclosure;

FIG. 3 shows a perspective view of the control element of the fluid connector at an open state according to the present disclosure;

FIG. 4 shows an exploded view of the fluid connector according to the present disclosure;

FIG. 5 shows an exploded view of the fluid connector from another perspective;

FIG. 6 shows an exploded view of a portion of the fluid connector according to the present disclosure;

FIG. 7 shows an exploded view of FIG. 6 from another perspective;

FIG. 8 shows a cross-sectional view along cut line A-A of FIG. 2;

FIG. 9 shows a cross-sectional view along cut line B-B of FIG. 2;

FIG. 10 shows a cross-sectional view of the fluid connector after abutting the matching connector according to the present disclosure;

FIG. 11 shows a cross-sectional view of the fluid connector of FIG. 10 after being rotated such that a pin member thereof is inserted into an engagement hole of the matching connector;

FIG. 12 shows a cross-sectional view along cut line C-C of FIG. 3; and

FIG. 13 shows a cross-sectional view along cut line D-D of FIG. 3.

### DETAILED DESCRIPTION OF THE DRAWINGS

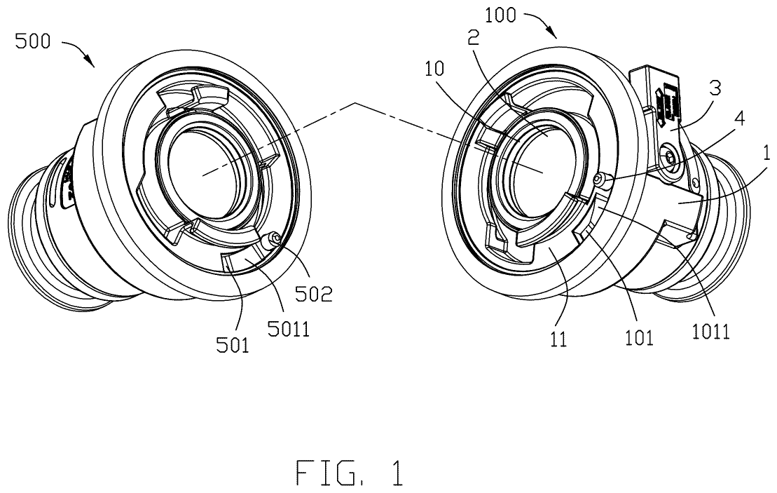

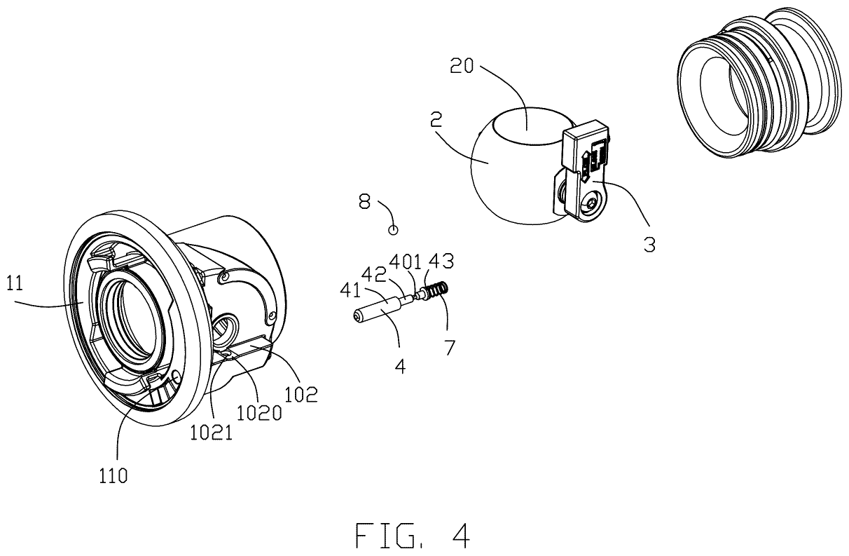

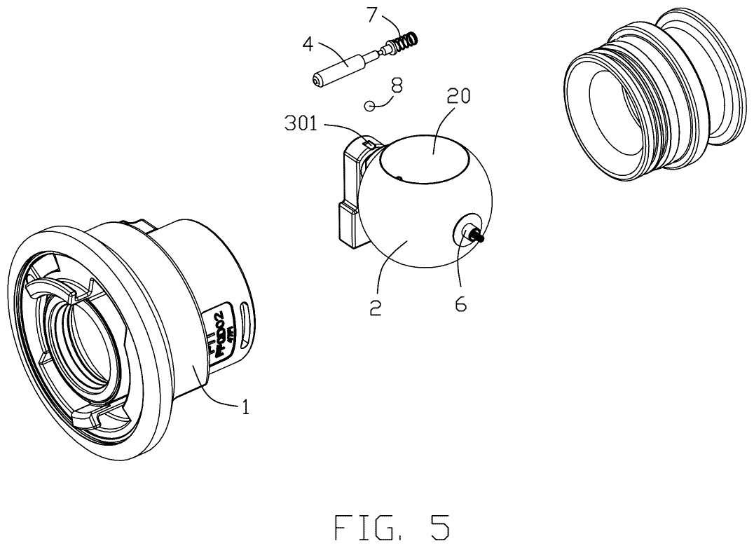

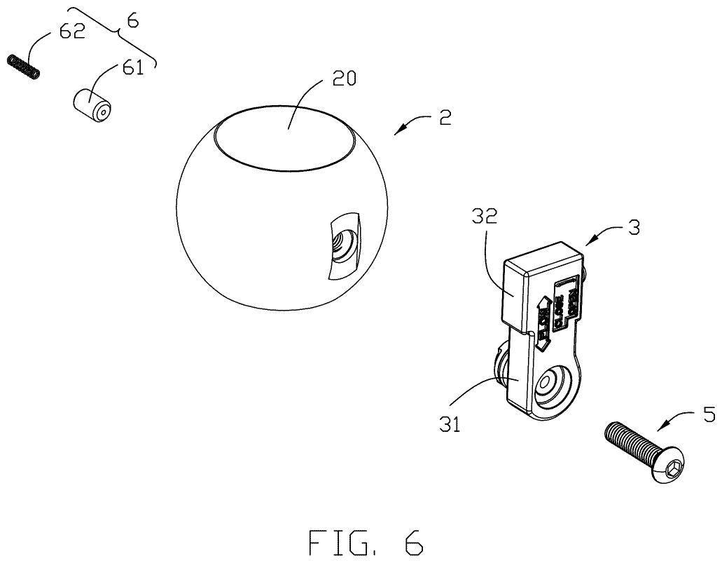

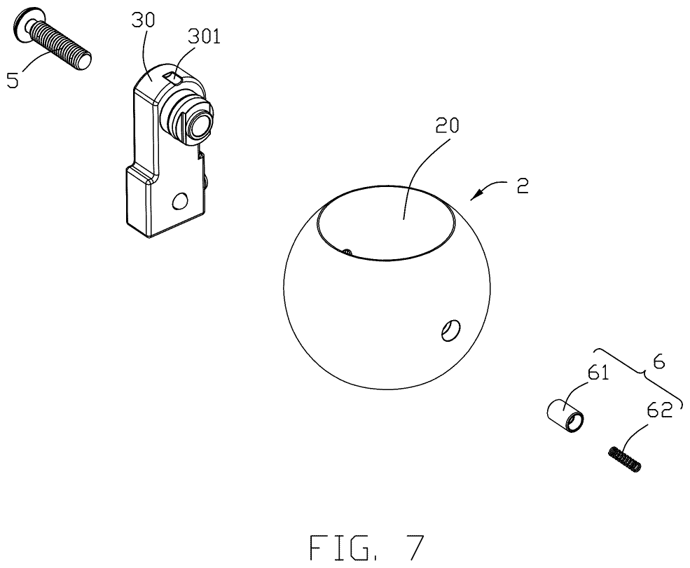

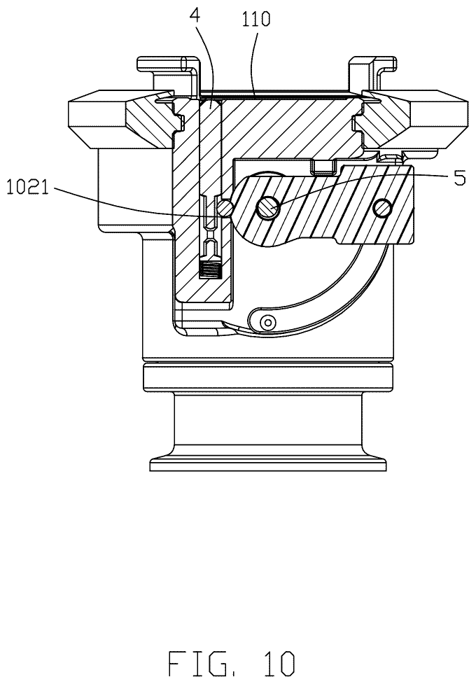

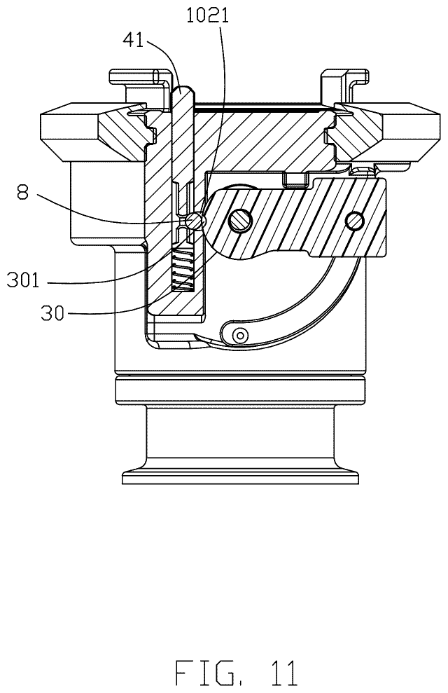

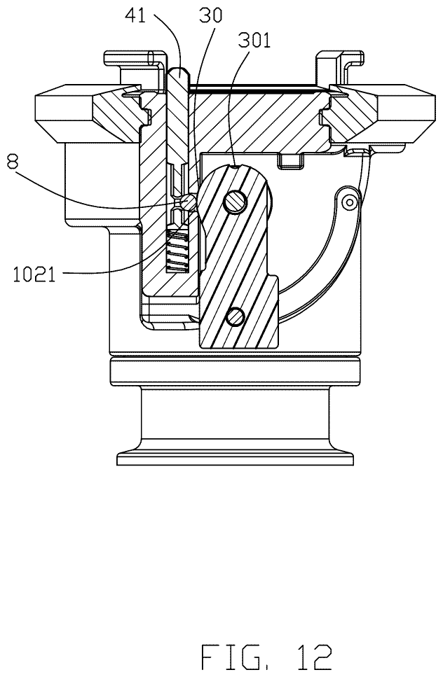

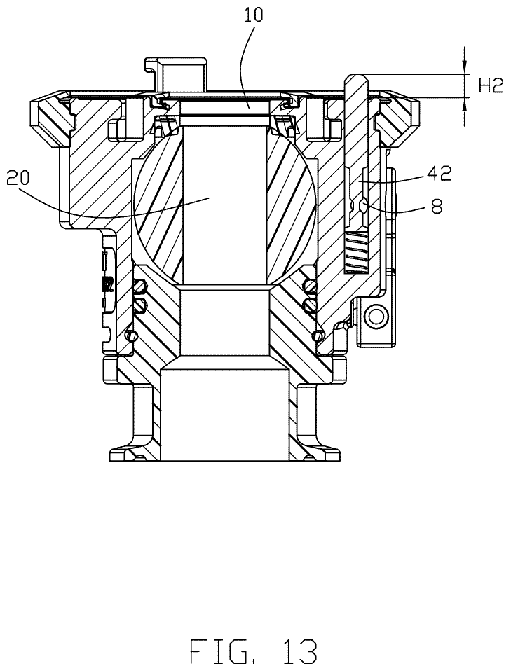

Referring to FIGS. 1-13, the present disclosure discloses a fluid connector 100, for connecting to a matching connector 500 such that the two connectors are in fluid communication with each other. The fluid connector 100 includes a shell 1 having a fluid channel 10, a ball valve 2 accommodated in the shell 1 and having a through hole 20, a control element 3 installed outside the shell 1 and connected to the ball valve 2 for controlling a rotation of the ball valve 2, and a pin member 4 protruding from a front face 11 of the shell 1 for engaging an engagement hole 501 arranged on a front end of the matching connector 500 The fluid connector 100 has a structure similar to that of the matching connector 500. The fluid connector 100, besides having the pin member 4, also has an engagement hole 101 arranged at a front end of the shell 1. The matching connector 500, besides having the engagement hole 501, also has a pin member 502. When the fluid connector 100 engages the matching connector 500 and rotates to position, the pin member 4 of the fluid connector 100 enters the engagement hole 501 of the matching connector 500, and the pin member 502 of the matching connector 500 enters the engagement hole 101 of the fluid connector 100, thereby realizing a locking function between the two connectors, effectively eliminating leakage.

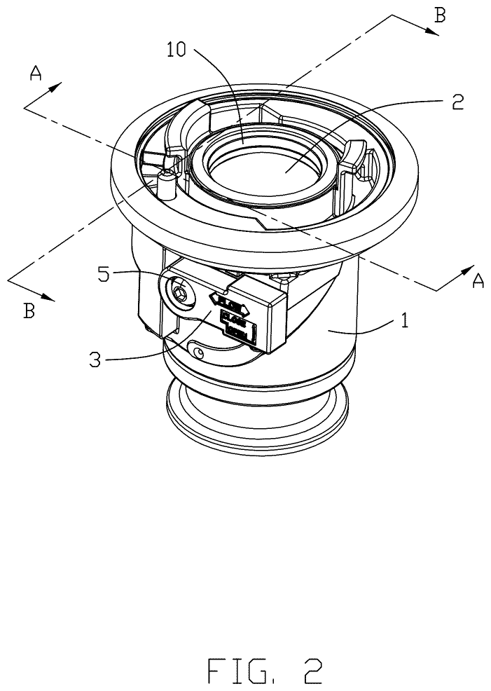

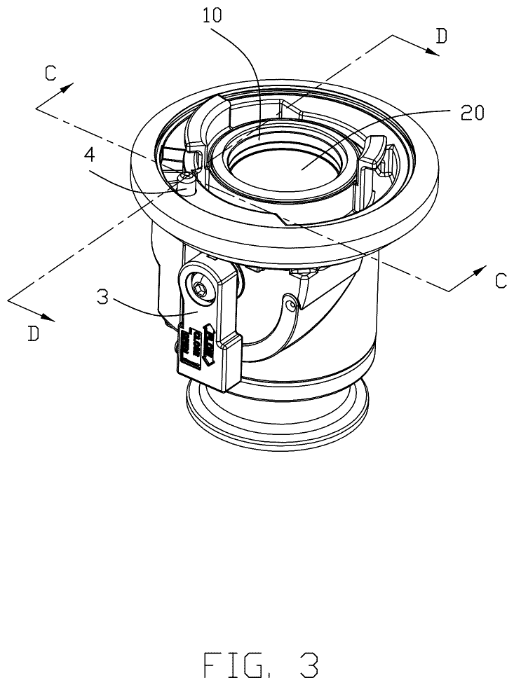

The control element 3 controls the ball valve 2 to rotate between a closed position for obstructing the flow channel and an open position for opening the flow channel. Referring to FIGS. 2, 8, and 9, when the control element 3 is not rotated, the through hole 20 of the ball valve 2 is not in fluid communication with the fluid channel 10. In this situation, the ball valve 2 is at the closed position for obstructing the fluid channel 10. Referring to FIGS. 3, 12, and 13, after the control element 3 rotates, the through hole 20 of the ball valve 2 is in fluid communication with the fluid channel 10. In this situation, the ball valve 2 is at an open position for opening the fluid channel 10. In the present disclosure, the control element 3 is fixedly connected to the ball valve 2 through a post member 5, so as to drive the rotation of the ball valve 2. At an opposite side of the ball valve 2 corresponding to the post member 5, a pivot member 6 is arranged in the shell 1. The pivot member 6 includes a pivot portion 61 having one end fixed to the ball valve 2 and another end pivotally arranged to the shell 1, and a spring 62 arranged in the pivot portion 61 and supported at the shell 1. The spring 62 can allow the ball valve 2 to securely rotate.

The front face 11 of the shell 1 has an accommodating hole 110 for accommodating the pin member 4. A resilient member 7 for supporting the pin member 4 is arranged in the accommodating hole 110. When the fluid connector 100 is not engaged to the matching connector 500, the pin member 4 is supported by the resilient member 7 and is at a first position protruding from the accommodating hole 110. When the fluid connector 100 abuts the matching connector 500, the pin member 4 is pressed by the matching connector 500 and compresses the resilient member 7, and is at a second position retracted in the accommodating hole 110. When the fluid connector 100 abuts the matching connector 500 and is rotated until the pin member 4 engages the engagement hole 501 of the matching connector 500, the pin member 4 is pushed by the resilient member 7 and extends to a third position into the engagement hole 501. To realize the above effect, the fluid connector 100 includes a restricting member 8 positioned between the control element 3 and the pin member 4. When the pin member 4 is at the first position or at the second position, the restricting member 8 restricts the control element 3 from rotating the ball valve 2. When the pin member 4 is at the third position, the control element 3 is not restricted by the restricting member 8 and can rotate the ball valve 2. Additionally, when the pin member 4 is at the third position and uses a rotation of the control element 3 to rotate the ball valve 2 to the open position, the pin member 4 is restricted by the restricting member 8 and cannot retract into the accommodating hole 110. Thus, the ball valve 2 cannot be unlocked in the open state, thereby preventing improper controlling from resulting in a loss of fluid.

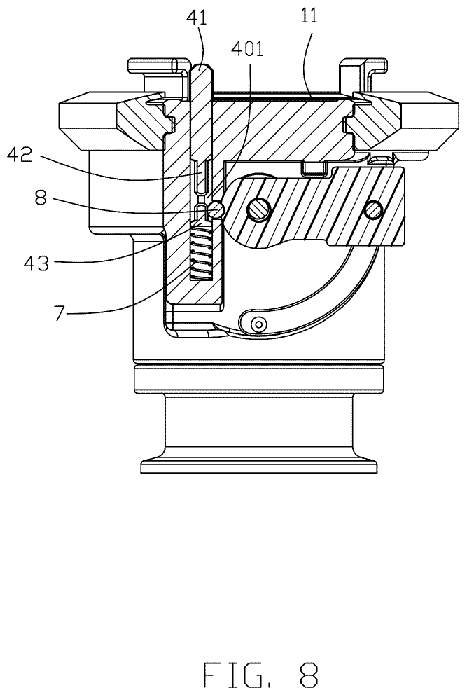

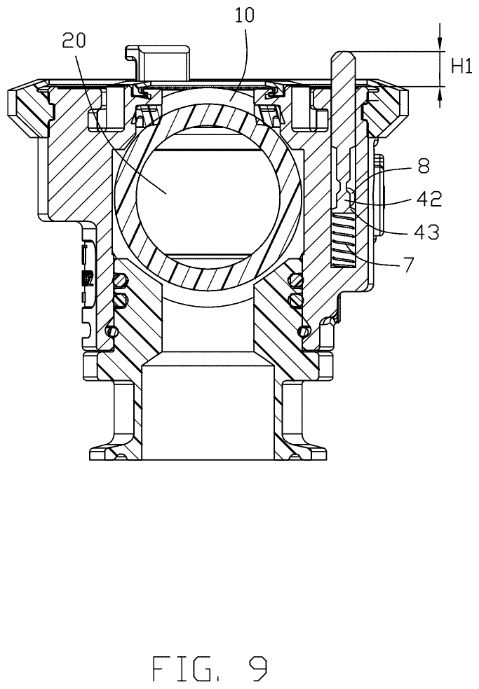

In the present disclosure, a periphery of the pin member 4 has a first groove 401. The control member 3 has a second groove 301. A periphery of the accommodating hole 110 passes through a wall face 102 of the shell 1, forming an outwardly exposing opening 1021. The restricting member 8 can switch positions between the first groove 401 and the second groove 301 through the opening 1021. Specifically, the control member 3 is a handle, and includes a base 31 having one end being a spherical face 30, and a handle 32 extending from another end of the base 31 for pressing operation. One end of the post member 5 is fixed to the base 31 and another end of the post member 5 is fixed to the ball valve 2. The spherical face 30 faces the wall face 102. The second groove 301 is arranged at the spherical face 30. The wall face 102 has a concave portion 1020 for engaging the spherical face 30. The opening 1021 is arranged in the concave portion 1020. When the control member 3 is at the position shown in FIG. 8, namely when the ball valve 2 is in an unopened state shown in FIG. 9, the second groove 301 and the opening 1021 are in aligned and in fluid communication. Referring to FIGS. 2, 8, and 9, when the pin member 4 is positioned at the first position or the second position, the first groove 401 and the second groove 301 are offset in a front-rear direction. The restricting member 8 is pushed by a portion of the pin member 4 outside the first groove 401 to a position between the opening 1021 and the second groove 301. At this moment, the restricting member 8 restricts the control element 3 from rotating, thus the ball valve 2 is unable to be opened. As shown in FIGS. 3, 12, and 13, when the pin member 4 is positioned at the third position, the first groove 401, the opening 1021, and the second groove 301 are aligned and in fluid communication. The control element 3 can rotation operation. The rotation operation of the control element 3 not only drives the ball valve 2 to open, but also further drives the restricting member 8 to separate from the second groove 301 and be positioned at the opening 1021 and the first groove 401.

In the present disclosure, the restricting member 8 is a ball. The pin member 4 has an upper portion 41 positioned at the upper end, and a lower portion 42 connected to and positioned below the upper portion 41. The resilient member 7 supports a bottom of the lower portion 42 such that the upper portion 41 protrudes from the accommodating hole 110. A diameter of the lower portion 42 is less than a diameter of the upper portion 41. The diameter of the upper portion 41 is substantially the same as an inner diameter of the accommodating hole 110. The periphery of the lower portion 42 is formed with the first groove 401. The diameter of the upper portion 41 is substantially the same as that of the accommodating hole 110 such that the pin member 4 can stably move in the accommodating hole 110. The diameter of the lower portion 42 is less than the inner diameter of the accommodating hole 110 such that when the restricting member 8 separates from the first groove 401, a space between the first groove 401 of the lower portion 42 and the accommodating hole 110 can accommodate the restricting member 8. When the pin member 4 is positioned at the first position, the restricting member 8 is positioned at a lower side of the first groove 401 and is pushed by the lower portion 42 into the second groove 301. The pin member 4 protrudes from the accommodating hole 110 by a first height H1. When the pin structure 4 is positioned at the second position, the restricting member 8 is positioned at an upper side of the first groove 401 and is pushed by the lower portion 42 into the second groove 301. The pin member 4 protrudes from the accommodating hole 110 by a second height H2 less than the first height H1. Additionally, for reliable support of the resilient member 7, a lower end of the lower portion of the pin member 4 has a base portion 42 having a diameter comparable to the diameter of the accommodating hole 110. The resilient member 7 supports a lower face of the base portion 43.

The engagement hole 501 of the matching connector 500 has a guide face 5011. When the ball valve 2 is at the open position, pressing the handle 32 can make the control element 3 drive the ball valve 2 to rotate from the open position to the closed position. The first groove 401, the opening 1021, and the second groove 301 return to a state of being in fluid communication with each other. At this moment the restricting member 8 is positioned at the first groove 401, the opening 1021, and the second groove 301. Then, rotating the fluid connector 100 in the other direction, the pin member 4 can be guided by the guide face 5011 and compress the resilient member 7 to separate from the engagement hole 501. At this moment, the restricting member 8 separates from the first groove 401 and is again pushed by the lower portion 42 of the pin member 4 outside the first groove 401 to the opening 1021 and the second groove 301, such that the pin member 4 is again at the first position. Similarly, the matching connector 500 can separate the pin member 502 through the guide face 1011 of the engagement hole 101 of the fluid connector 100 by using the above operation. Of note, the guide face 5011 facilitates guiding the pin member 4 to enter the engagement hole 501.

Of note, the fluid connector 100 of the present disclosure can engage matching connectors having different structures, as long as the matching connector has an engagement hole allowing the pin member 4 of the fluid connector 100 to be inserted and positioned at the third position, thereby unlocking the ball valve 2, and a pin member of the matching connector can be inserted into the engagement hole 101 of the fluid connector 100 for unlocking the ball valve.

1. A fluid connector comprising:
a shell having a fluid channel and an accommodating hole;
a ball valve accommodated in the shell and having a through hole;
a control element arranged outside the shell for controlling the ball valve to rotate between a closed position and an open position;
a pin member and a resilient member both arranged in the accommodating hole; and
a restricting member positioned between the control element and the pin member; wherein
the shell has an engagement hole;
the pin member is moveable between a first position extending out of the accommodating hole and a second position retracted in the accommodating hole; when the fluid connector abuts the matching connector and is rotated such that the pin member corresponds to an engagement hole of a matching connector, the pin member is pushed by the resilient member and is positioned at a third position extending into the engagement hole; when the pin member is positioned at the first position or at the second position, the restricting member prevents the control element from rotating the ball valve; and when the pin member is positioned at the third position, the control element is free of restriction by the restricting member and is able to control the ball valve to rotate.

2. The fluid connector according to claim 1, wherein when the pin member is positioned at the third position and the control element is used to rotate the ball valve to the open position, the pin member is restricted by the restricting member and is unable to retract into the accommodating hole.

3. The fluid connector according to claim 1, wherein when the pin member is positioned at the first position, the pin member protrudes from the accommodating hole by a first heigh, and when the pin member is positioned at the third position, the pin member protrudes from the accommodating hole by a second heigh less than the first height.

4. The fluid connector according to claim 1, wherein a periphery of the pin member has a first groove; the control element has a second groove; a periphery of the accommodating hole passes through a wall face of the shell to form an opening; the restricting member is able to switch positions between the first groove and the second groove through the opening; when the pin member is positioned at the first position or the second position, the first groove and the second groove are offset in a front-rear direction, the restricting member is pushed by a portion of the pin member outside the first groove, and the restricting member restricts the control element from rotating; and when the restricting member is positioned at the third position, the first groove, the opening, and the second groove are aligned, the control element is able to perform a rotation operation, and the rotation operation of the control element drives the restricting member to separate from the second groove and be positioned at the opening and the first groove.

5. The fluid connector according to claim 4, wherein the restricting member is a ball; the pin member has an upper portion positioned at an upper end and extendable out of a front face of the shell, and a lower portion connected to and positioned below the upper portion; a diameter of the lower portion is less than a diameter of the upper portion; the diameter of the upper portion is substantially the same as an inner diameter of the accommodating hole; the resilient member supports a lower side of the lower portion; a periphery of the lower portion has the first groove; when the restricting member is positioned at the first positioned, the restricting member is positioned at a lower side of the first groove and pushed by the lower portion into the second groove; and when the restricting member is positioned at the second position, the restricting member is positioned at an upper side of the first groove and pushed by the lower portion toward the second groove.

6. The fluid connector according to claim 4, wherein the engagement hole of the matching connector has a guide face; when the control element drives the ball valve to rotate from the open position to the closed position, the first groove, the opening, and the second groove are aligned, the restricting member is positioned at the first groove, the opening, and the second groove; and when rotating the fluid connector, the restricting member is able to separate from the engagement hole by guidance of the guide face, the restricting member separates from the first groove and is pushed by a portion of the pin member outside the first groove to the opening and the second groove, such that the pin member returns to the first position.

7. The fluid connector according to claim 4, wherein the control member is connected to the ball valve through a post member and comprises a base having one end being a spherical face, and a handle integrally extending from another end of the base for press operation; one end of the post member is fixed to the base and another end of the post member is fixed to the ball valve; and the spherical face of the base faces the opening and has the second groove.

8. The fluid connector according to claim 7, wherein the shell has a wall face opposite the spherical face of the base, the wall face has a concave portion engaging the spherical face, and the opening is arranged a the concave portion.

9. The fluid connector according to claim 1, wherein the engagement hole of the matching connector has a guide face, and when the fluid connector rotates with respect to the matching connector, the guide face guides the pin member to enter or retreat from the engagement hole.

10. The fluid connector according to claim 1, wherein the fluid connector and the matching connector have similar structures, and the fluid connector has an engagement hole for engaging a pin member of the matching connector.
